(19) United States
(12) Patent Application Publication
(10) Pub. No.: US 2024/0254321 A1
(43) Pub. Date: Aug. 1, 2024

(54) BIOMASS MICROBEADS AND METHODS OF PRODUCING MICROBEADS

(71) Applicant: Regents of the University of Minnesota, Minneapolis, MN (US)

(72) Inventors: Michelle Anna Calabrese, Minneapolis, MN (US); Benjamin Per Robertson, Minneapolis, MN (US); Gerald Edmund Rott, Minneapolis, MN (US)

(73) Assignee: Regents of the University of Minnesota, Minneapolis, MN (US)

(21) Appl. No.: 18/430,203

(22) Filed: Feb. 1, 2024

Related U.S. Application Data
(60) Provisional application No. 63/442,607, filed on Feb. 1, 2023.

(51) Int. Cl. C08L 1/02; C08J 3/14; C08L 97/00

(52) U.S. Cl. CPC C08L 1/02; C08J 3/14; C08L 97/005; C08J 2301/02; C08J 2397/00; C08L 2201/06

(57) ABSTRACT

Microbeads including about 50 wt % to about 99 wt % cellulose and about 1 wt % to about 50 wt % lignin. An average diameter of the microbeads is in a range of about 25 microns to about 1500 microns. Producing the microbeads includes dissolving cellulose and lignin in a solvent to yield a biomass solution, introducing the biomass solution into oil to yield a first mixture, adding an anti-solvent to the first mixture to yield a second mixture, and precipitating the microbeads from the second mixture.

### CROSS-REFERENCE TO RELATED APPLICATION

This application claims the benefit of U.S. patent application Ser. No. 63/442,607, filed on Feb. 1, 2023, which is incorporated herein by reference in its entirety.

### GOVERNMENT SUPPORT

This invention was made with government support under CHE1901635 awarded by the National Science Foundation. The government has certain rights in the invention.

### TECHNICAL FIELD

The present disclosure relates to biomass microbeads and methods of producing biomass microbeads via a surfactant-free batch emulsion method.

### BACKGROUND

Plastic microbeads, typically composed of non-degradable synthetic polymers like polyethylene and polypropylene, are used as exfoliants and rheological modifiers in personal care and cosmetic products (PCCPs) to improve viscosity, bulking, film formation, and abrasion. The quantity of microbeads in PCCPs can be substantial; yet unlike the plastic used to package these products, microbeads cannot be readily collected for recycling since they directly enter the water waste stream upon use.

Limited sustainable alternatives to plastic microbeads on the desired size scale to the PCCP industry currently exist. Some systems employ covalent crosslinking to stabilize the microbeads or utilize derivatized biomass. However, crosslinking and derivatization can negatively impact enzymatic degradation of beads and some kinds of derivatization can result in harmful degradation products. Other systems are not characterized with respect to mechanical stability or require specific conditions for cellulose dissolution that are difficult to replicate and limit the window for industrial processing.

### SUMMARY

This disclosure describes microbeads and methods of making the microbeads. The microbeads include about 50 wt % to about 99 wt % cellulose and about 1 wt % to about 50 wt % lignin. The microbeads have an average diameter in a range of about 25 microns to about 1500 microns.

In some embodiments, the microbeads include about 1 wt % to about 25 wt %, or 10 wt % to about 20 wt % lignin (e.g., Kraft lignin). The cellulose can have a degree of polymerization in a range of about 200 to about 500. The microbeads can be free of surfactant, metal oxides, or both. A Young's modulus of the microbeads is typically in a range of about 0.5 GPa to about 1.5 GPa (e.g., about 1 GPa). An average diameter of the microbeads is typically in a range of about 150 microns to about 800 microns (e.g., about 100 microns to about 500 microns). In some cases, the microbeads are spherical.

Making the microbeads includes dissolving cellulose and lignin in a solvent to yield a biomass solution, combining the biomass solution and oil to yield a first mixture, combining an anti-solvent and the first mixture to yield the second mixture, and precipitating the microbeads from the second mixture. Combining the biomass solution and the oil can include introducing the biomass solution into the oil. Combining the anti-solvent and the first mixture can include adding the anti-solvent to the first mixture.

Making the microbeads can include separating (e.g., sieving) the microbeads from the second mixture and removing solvent and anti-solvent from the microbeads. In one example, removing the solvent and the anti-solvent includes a thermal extraction. The solvent can be an ionic liquid (e.g., 1-ethyl-3-methylimidazolium acetate (EMImAc)).

A concentration of the cellulose in the biomass solution is typically in a range of about 1 wt % to about 10 wt %. A concentration of the lignin in the biomass solution is typically in a range of about 1 wt % to about 10 wt %. In some embodiments, a total concentration of biomass (e.g., cellulose and lignin) in the biomass solution is about 4 wt %.

Examples of suitable anti-solvents include water, ethanol, and any combination thereof. The first mixture and the second mixture are typically free of surfactant. The oil can be mineral oil. Combining the biomass solution and the oil can include dripping (e.g., with a needle having a diameter in a range of from 0.25 mm to 0.75 mm). The oil can be at a temperature in a range of about 30° C. to about 50° C. A weight ratio of anti-solvent:oil:ionic liquid in the second mixture is typically in a range of about 20 to about 25:about 1 to about 5:about 1.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE FIGURES

FIG. 1 depicts a life cycle of sustainable rheological modifiers.

FIG. 2 depicts an exemplary method of producing microbeads.

FIG. 3 shows a scanning electron microscope (SEM) image of a microbead produced by a method disclosed herein.

FIG. 4 shows an SEM image of a microbead produced by a method disclosed herein.

FIG. 5 shows an SEM image of a microbead produced by a method disclosed herein.

FIG. 6 shows the size distribution of microbeads produced by a method disclosed herein.

FIG. 7 shows an energy-dispersive x-ray spectroscopy (EDS) spectrum of microbeads prior to extraction in ethanol, indicating the presence of residual ionic liquid (IL).

FIG. 8A shows an SEM image of a microbead produced by a method described herein.

FIG. 8B shows an SEM image of a microbead produced by a dripping synthesis procedure without an emulsion.

FIG. 9 is a table showing SEM images of microbeads made with different oils and properties of those oils.

FIG. 10 shows process modifications to facilitate scale-up and improve yield of non-aggregated beads.

FIG. 11 is an SEM image showing beads taken from a mineral oil/S600 sample with bead sizes as small as 30 μm or 40 μm.

FIG. 12 shows SEM images of microbeads and characterization of average microbead diameter and sulfur incorporation from lignin with increasing initial lignin content.

FIG. 13 shows images of microbeads made with and without surfactant at varying initial lignin content.

FIG. 14 shows the effect of surfactant on lignin retention.

FIGS. 15A and 15B show viscosity and viscosity ratio, respectively, of model cream with and without microbeads.

### DETAILED DESCRIPTION

This disclosure describes microbeads and methods of making the microbeads. The microbeads include about 50 wt % to about 99 wt % cellulose and about 1 wt % to about 50 wt % lignin. The microbeads have an average diameter in a range of about 25 microns to about 1500 microns.

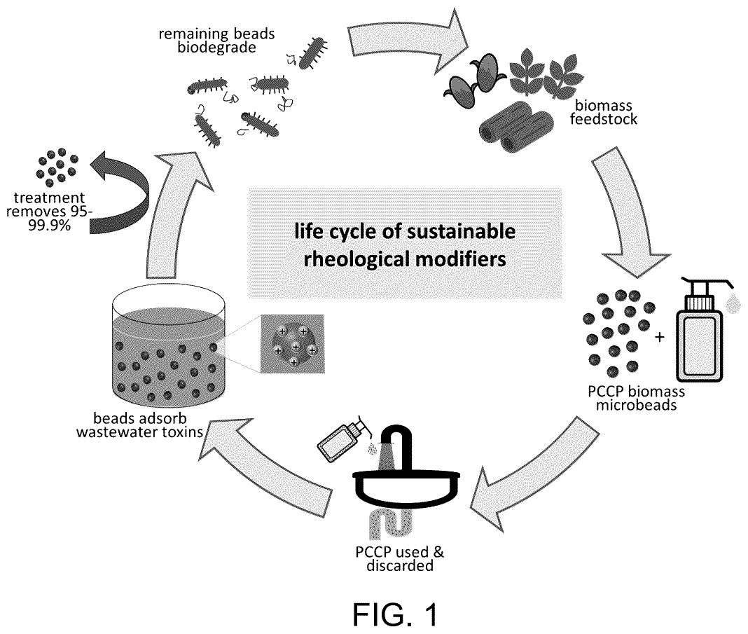

FIG. 1 shows a life cycle of sustainable rheological modifiers. The biomass microbeads disclosed herein utilize nonderivatized biomass from abundant waste sources. The microbeads are able to retain desirable properties for rheological property modification (e.g., bulking, viscosity), for example in personal care consumer products, without contributing to microplastic pollution. Biocompatible and biodegradable microbeads sourced from biomass feedstock can provide a sustainable alternative to plastic microbeads currently sourced from synthetic polymers. Microbeads from biomass (e.g., cellulose and lignin), which is typically burned or used in low-value products, have been previously used for pollutant capture and environmental remediation. As the majority of plastic microbeads in PCCPs are captured during wastewater treatment, these bio-based microbeads may have additional utility after consumer use due to their adsorption and water purification capabilities. For example, after the beads are discarded, the adsorbent properties of biomass can be utilized to passively remove other toxins, like heavy metals and pharmaceuticals, from water in the environment. Once toxins have accumulated in the beads, the beads can be allowed to settle in sedimentation tanks as part of the water treatment process. Most of the beads can be removed, and the remaining beads left in the environment can biodegrade, preventing the bioaccumulation of adsorbed toxins.

The microbeads disclosed herein incorporate mixed feedstocks that make the process of producing the microbeads robust to the biomass used. In some embodiments, the microbeads include about 1 wt % to about 50 wt % lignin (e.g., about 1 wt % to about 25 wt %, or about 10 wt % to about 20 wt % lignin). In some embodiments, some or all of the lignin is Kraft lignin-a low value byproduct of cellulose extraction.

In some embodiments, the cellulose has a degree of polymerization in a range of about 200 to about 500 (e.g., about 200 to about 300). In some embodiments, the microbeads do not comprise oxidized cellulose.

In some embodiments, the microbeads have an average diameter in a range of about 25 μm to about 1500 μm (e.g., about 150 μm to about 800 μm). Although microbeads are commonly defined as particles ranging in diameter from about 0.1 to about 5 mm, particles in commercial PCCPs are anywhere from tens of microns in diameter to over a millimeter. However, wastewater treatment plants typically use screens and settling tanks to remove microparticles, meaning that particles smaller than about 200 μm may be more likely to escape into the environment. Beyond this limit, a preferred size of microbeads depends on their intended application-whereas microbeads in toothpaste are usually less than about 400 μm, many microbeads found in skin cleaning products like facial and body scrubs are larger, from about 450 μm to about 800 μm. Larger beads are generally more powerful exfoliants, whereas smaller beads may be more suited as rheological modifiers due to the increased colloidal interactions between beads. In some embodiments, while larger or smaller microbeads could be used as filler particles or as more powerful exfoliants, respectively. A target range for sustainable microbeads in consumer products is typically from about 200 μm to about 800 μm in diameter, large enough to be captured in wastewater treatment processes, and small enough to be used in different personal care consumer products.

Also provided herein is a method of producing biomass microbeads via a surfactant-free batch emulsion method. The method includes dissolving cellulose and lignin in a solvent to yield a biomass solution, combining the biomass solution and oil to yield a first mixture, combining an anti-solvent and the first mixture to yield the second mixture, and precipitating the microbeads from the second mixture. The first mixture, the second mixture, or both can be an emulsion. Combining the biomass solution and the oil can include introducing the biomass solution into the oil. Combining the anti-solvent and the first mixture can include adding the anti-solvent to the first mixture.

In some embodiments, the method further includes separating the microbeads from the second mixture and removing solvent and anti-solvent from the microbeads. In some embodiments, the separating includes filtering the microbeads. In some embodiments, removing the solvent and anti-solvent includes a thermal extraction. In one example, the thermal extraction is a Soxhlet extraction. Some embodiments further include sieving the microbeads.

In some embodiments, the emulsion process includes dissolving mixtures of cellulose and Kraft lignin in a solvent, mixing with oil, and combining anti-solvent slowly with the emulsion to precipitate beads before performing a thermal (e.g., Soxhlet) extraction to remove residual solvent.

In some embodiments, the solvent is an environmentally benign and/or easily recyclable solvent. In some embodiments, the solvent is an ionic liquid (IL). In some embodiments, the ionic liquid is selected from 1-ethyl-3-methylimidazolium acetate (EmImAc), 1-butyl-3-methylimidazolium acetate, 1-butyl-3-methylimidazolium chloride, 1-ethyl-3-methylimidazolium chloride, and mixtures thereof. In some embodiments, the ionic liquid is EMImAc.

In some embodiments, a concentration of the cellulose in the biomass solution is in a range of about 1 wt % to about 10 wt %. In some embodiments, a concentration of the cellulose in the biomass solution is about 5 wt % to about 10 wt %. In some embodiments, a concentration of the cellulose in the biomass solution is about 8 wt %.

In some embodiments, a concentration of the lignin in the biomass solution is about 1 wt % to about 10 wt %. In some embodiments, a concentration of the lignin in the biomass solution is about 2 wt % to about 6 wt %. In some embodiments, a concentration of the lignin in the biomass solution is about 4 wt %.

In some embodiments, a total concentration of biomass in the biomass solution is about 4 wt %. “Biomass,” as used herein, refers to mass that is derived from organisms, for example, cellulose and lignin.

In some embodiments, the anti-solvent includes water, ethanol, or a combination thereof. In some embodiments, the anti-solvent is ethanol.

In some embodiments, the emulsion method can be performed at low temperatures, such as at about 40° C., or at room temperature. In one example, the oil the solvent are both kept at 40° C. In some embodiments, the oil is at a temperature in a range of about 30° C. to about 50° C.

The emulsion (e.g., the first mixture, the second mixture, or both) can be formed without surfactant. In one example, the first mixture and the second mixture are free of surfactant. In some embodiments, the microbeads are free of metal oxides, such as iron oxide. In some embodiments, the microbeads are free of curing agent.

The method of producing microbeads disclosed herein does not require crosslinking to produce stable microbeads. In some embodiments, the method is free of crosslinking. In some embodiments, the method produces microbeads using biomass feedstocks with a fraction of lignin up to 0.5.

The method includes introducing the biomass solution into oil. In some embodiments, introducing includes dripping. In some embodiments, dripping is performed with a needle having a diameter in a range of from 0.25 mm to 0.75 mm (e.g., 0.30 mm, 0.48 mm, or 0.71 mm). The method is robust to different oils, for example, heavy mineral oil with viscosity of 9 mPa·s and 0.88 g/mL, but also successfully producing beads with viscosity standard s600 (1273 mPa·s and 0.87 g/mL) and tetradecane (2 mPa·s and 0.76 g/mL). Suitable oils include mineral oil, vegetable oil, or a combination thereof. One example of a vegetable oil is sunflower oil; other known oils may also be used.

In some embodiments, a weight ratio of anti-solvent:oil:ionic liquid in the second mixture is in a range of about 20 to about 25:about 1 to about 5:about 1. In some embodiments, a weight ratio of anti-solvent:oil:ionic liquid is 20.5:1:1. In some embodiments, a weight ratio of anti-solvent:oil:ionic liquid is 20.5:2:1. In some embodiments, a weight ratio of anti-solvent:oil:ionic liquid is 20:4:1.

In some embodiments, making the microbeads further includes stirring the first mixture and/or second mixture. In some embodiments, the first mixture and/or second mixture is stirred at about 250 rpm. In some embodiments, the first mixture and/or second mixture is stirred with a stir bar. In some embodiments, the first mixture and/or second mixture is stirred with an impeller.

The biomass microbeads disclosed herein have applications in the personal care and consumer products industry. Methods of producing biomass microbeads disclosed herein can yield beads in the size and modulus range of interest to these industries. Further, the biomass microbeads are environmentally friendly (e.g., residual solvent is removed) and biodegradable (no crosslinking required) and produced via a scalable process that requires minimal energy input and is robust to biomass feedstock.

In some embodiments, the microbeads have a Young's modulus in a range of about 0.5 GPa to about 1.5 GPa. In some embodiments, the microbeads have a Young's modulus of about 1 GPa. Young's modulus of the microbeads can be measured by atomic force microscopy. In some embodiments, the Young's modulus is measured by mechanical single particle compression testing.

In some embodiments, the microbeads are spherical. A shape of the microbeads can be measured by scanning electron microscopy for a qualitative approximation, and can be quantified via aspect ratios of bead distributions (shape analysis from images used for sizing). In one example, top-down images of the beads are thresholded in ImageJ, and the aspect ratio of each bead can be determined by the ratio of major to minor axes in an elliptical fit of the bead area.

### EXAMPLES

### Materials

Avicel PH-101 (degree of polymerization (DP)=230) and MCC 102 (DP=290) cellulose powders were used as-received (Sigma-Aldrich). Kraft dealkaline lignin was purchased from TCI Chemical. Ionic liquid (or EMImAc) (1-ethyl-3-methyl-imidazolium acetate) was purchased from Astatech (95% purity).

### Emulsion Synthesis

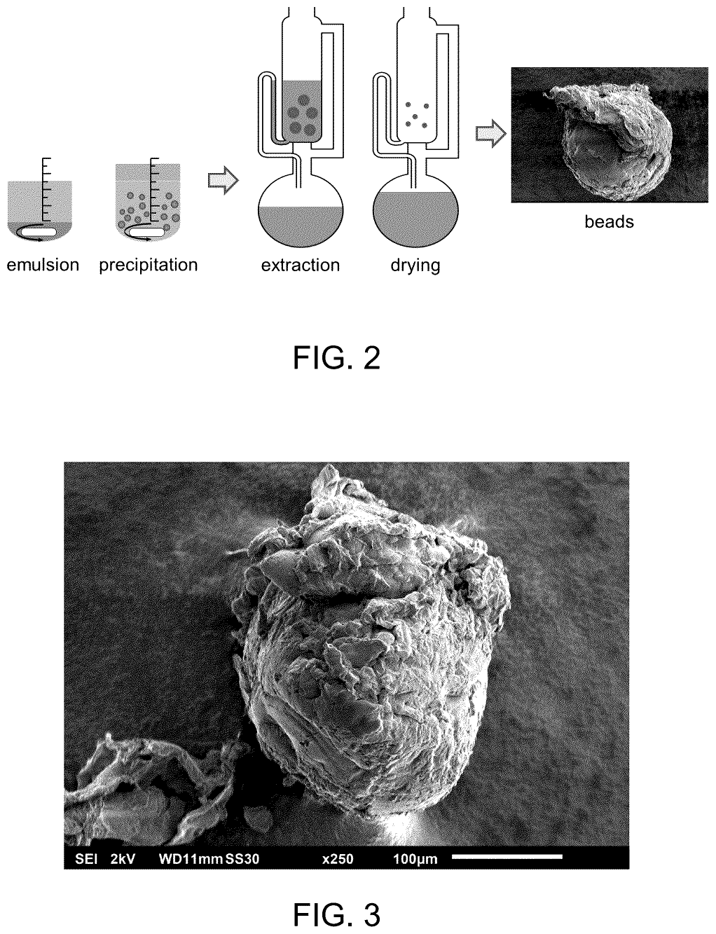

FIG. 2depicts a scalable batch emulsion synthesis. Droplets of a biomass solution (4% weight total cellulose and lignin in EMImAc) were added to an amount of mineral oil five times its weight to form an emulsion and stirred at 40° C. for 2 hours. An amount of ethanol 20 times the weight of the biomass solution was then added dropwise (approximately two drops per second) to the emulsion to cause precipitation of the beads, maintaining the temperature of the emulsion at 40° C. via a hot plate. Beads were then filtered out by pouring the solution through filter paper; beads were then rinsed with ethanol and hexanes to remove residual mineral oil. Finally, the beads were placed into a Soxhlet apparatus and extracted with 200 mL of ethanol overnight, before being removed from the Soxhlet apparatus and allowed to dry in ambient conditions for at least 8 hours.

Several process parameters were adjusted, including component ratios, reactor geometry, mixing conditions, and temperature. Temperature reduces viscosity of the ionic liquid solution, which helps disperse those droplets, but heating the ionic liquid too much can lead to side reactions with the cellulose, resulting in discoloration, as well as preventing the addition of anti-solvents like ethanol with low boiling points. Stirring faster or more efficiently as with the impeller shown here results in smaller beads as the droplets are broken up more, but it can also deform the beads. However, in some cases, stirring at a minimum speed is required to break up the mixture into droplets. Reactor geometry is preferably matched to the size of the stir bar or impeller, to promote mixture of the entire volume, avoiding the creation of a ring of cellulose, and can impact mixing efficiency. Finally, regarding choice of components-a denser oil better matches the ionic liquid density, and miscibility of the oil with ethanol facilitates precipitation. More oil helps disperse the IL, and may improve emulsion stability. While surfactant may improve emulsion stability, omission of the surfactant simplifies the process and facilitates more facile separation of the microbeads after synthesis.

### Scanning Electron Microscopy (SEM)

Images of microbead surfaces were obtained using a scanning electron microscope (JEOL JSM-6010PLUS/LA). The beads were affixed to an adhesive carbon tape without sputter coating. SEM observations were carried out with a secondary electron detector at an acceleration voltage of 2 kV to avoid charging effects, with magnifications from 50× to 1000×. Energy-dispersive x-ray spectroscopy (EDS) was performed at an acceleration voltage of 5 kV to ensure sufficient signal (at least 20000 counts per second) for elemental analysis. To determine the microbead internal structure, a microbead was flash-frozen in liquid nitrogen and sectioned with a scalpel.

SEM images of microbeads are shown in FIGS. 3-5. FIG. 3 shows an image of a bead produced from an emulsion with 4% wt. cellulose (DP 230) in EMImAc-20:5:1 ethanol:oil: ionic liquid solution by weight at 40° C. and stirring at 250 RPM. Imaging by SEM was carried out at an acceleration voltage of 2 kV and 250× scale on carbon tape.

### Controlling Bead Morphology—Mixing Conditions

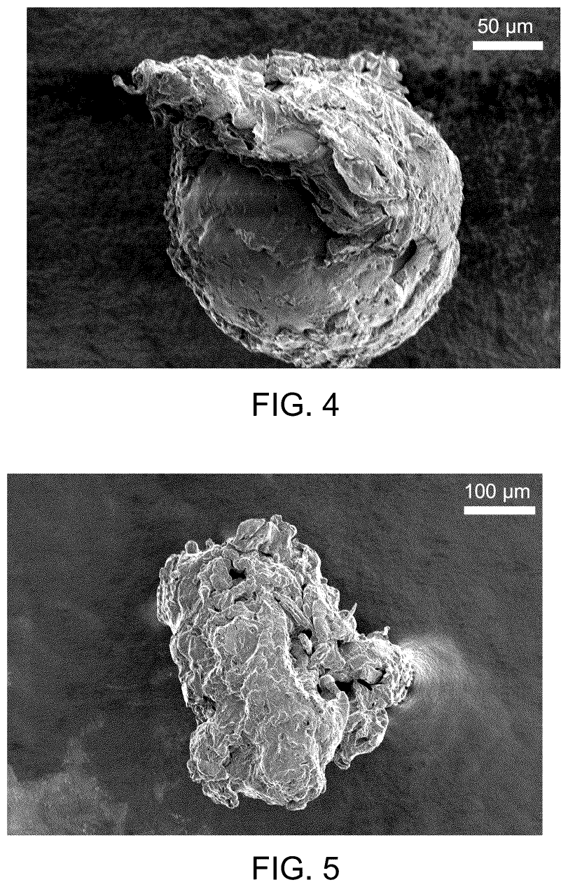

The microbead shown in FIG. 4 was produced by an emulsion with a component ratio of 20:5:1 ethanol:oil:IL, stirred 250 rpm for 2 hours at 40° C. with a stir bar.

The microbead shown in FIG. 5 was produced by an emulsion with a component ratio of 20:5:1 ethanol:oil:IL, stirred 240 rpm for 2 hours at 40° C. with an impeller. Therefore, the same conditions were used as for the microbead shown in FIG. 4, the same component ratios, stir speed, and temperature, but instead of a stir bar, an impeller was used. As shown in FIG. 5, this resulted in some very flat, flaky beads, indicating that the more efficient stirring from the impeller may have deformed the beads. To remedy this, some options include reducing the stirring speed or the temperature.

### Microbead Size Quantification

Large batches of beads were placed on white paper and photographed together from above via a Samsung Galaxy S9+phone camera with pixel resolution of 4032 by 3024. Images were then analyzed using Image J, and sized based on a ruler used in the images as reference. Sizing on Image J was performed manually using the ellipse tool or using a color threshold depending on the quality and contrast of the image, and the average diameter D_{bead} were determined based on the area of each ellipse as D_{bead}=√(4A/π). Many (at least n=100 for larger samples, n=5 for smaller samples) beads were sized to produce a reliable estimate of variance based on sample standard deviation, and statistical significance was determined via a two-sample, one-tailed Student's t-tests (assuming unequal variances). The average bead size prior to extraction (D_{precip}) varied from D_{bead} to 3D_{bead} depending on precipitation and extraction solvents, and this decrease in size after extraction was attributed largely to the removal of residual ionic liquid.

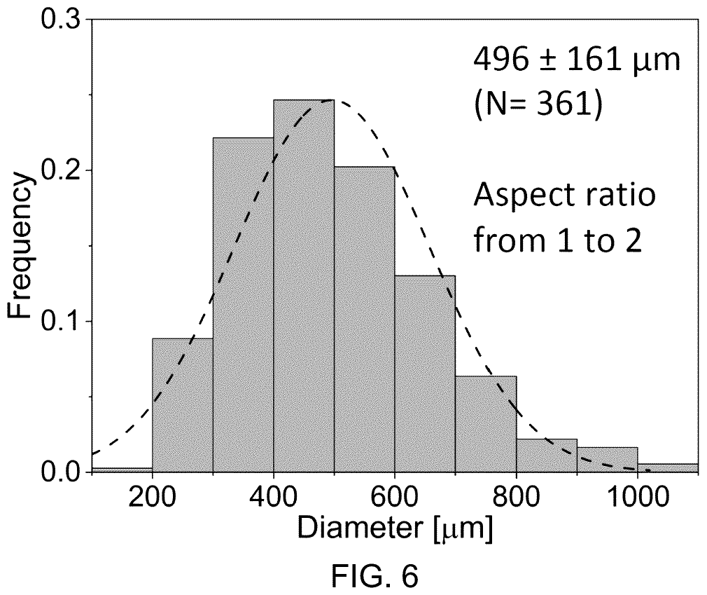

Size distribution of the microbeads is shown in FIG. 6, with an average size under 500 microns. More monodisperse samples may be produced using sieving as a separation technique.

### Surface Roughness and Elemental Analysis

Elemental analysis was performed using energy-dispersive X-ray spectroscopy using a scanning electron microscope (JEOL JSM-6010PLUS/LA) at an acceleration voltage of 5 kV to ensure sufficient signal (at least 20000 counts per second). Incorporation of EMImAc was determined based on the weight percentage of nitrogen in EMImAc (17.9%) and the measured weight percentage of nitrogen in the beads by EDS.

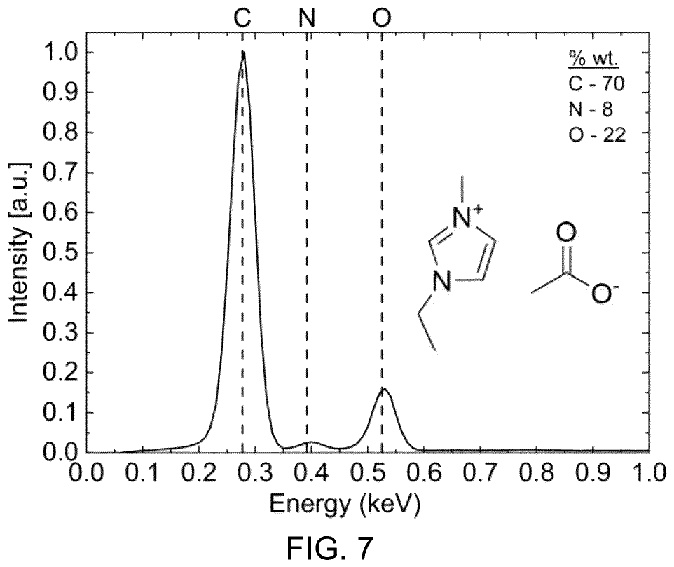

FIG. 7 shows an energy-dispersive X-ray spectroscopy (EDS) spectrum of microbeads prior to extraction in ethanol, indicating the presence of residual ionic liquid, based on the presence of a nitrogen peak which can be attributed to the nitrogen in 1-ethyl-3-methylimidazolium acetate. FIG. 7 indicates that the microbead is comprised of 8% nitrogen, indicating that as much as 47% of the bead is comprised of ionic liquid prior to extraction. This measurement corresponds with the reduction in bead size following extraction.

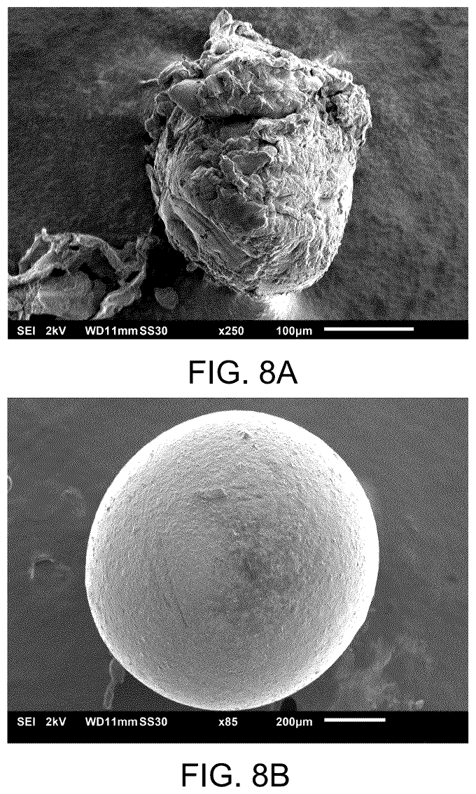

FIGS. 8A and 8B show a comparison of a microbead produced by an emulsion synthesis (FIG. 8A), and a comparative microbead that was synthesized without an emulsion (FIG. 8B). The microbead synthesized by the emulsion method described herein (FIG. 8A) has a much rougher surface than the microbead synthesized without an emulsion (FIG. 8B). The roughness of the beads may advantageously improve their function as exfoliants.

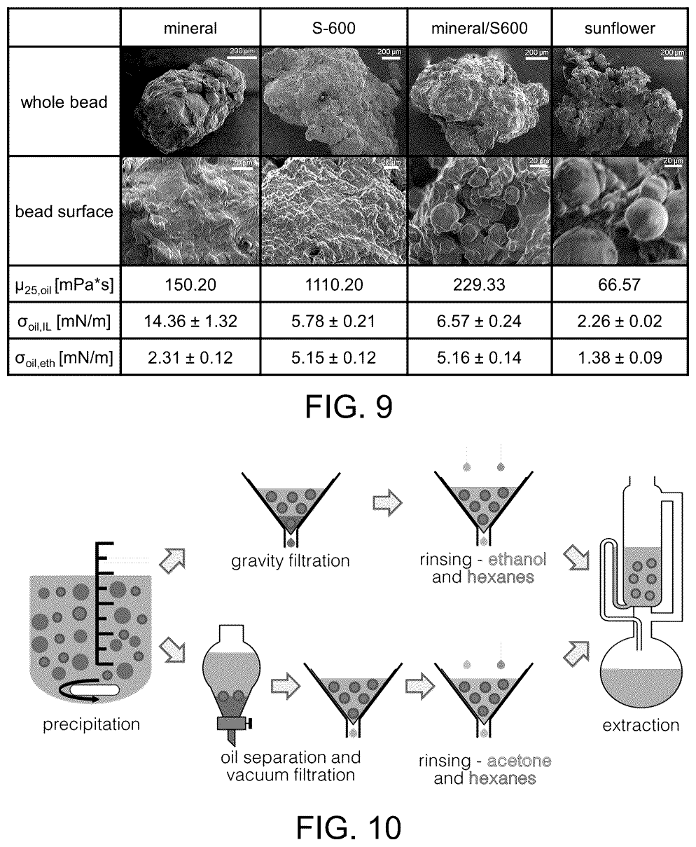

Although emulsions are possible incorporating a wide range of oils, profound morphological changes can be seen as a result of the choice of oil. For conditions described herein (5:1 oil:ionic liquid, stirring at 250 RPM at a temperature of 40° C.), use of mineral oil results in relatively spherical beads as seen by SEM, and a closer look at their surface reveals no regular pore structure or raised pattern. Use of S600 results in more condensed but irregular beads, with very small bumps on the surface which make the bead look “rougher” at a lower magnification. Use of a mixture of mineral oil and S600 (75/25 by weight) results in somewhat regular beads with visible bumps. These bumps are larger than those formed on the S600 beads, but still appear connected to the bulk of the bead. Finally, use of sunflower oil results in a different morphology, with beads having small, spherical growths attached to the surface, ranging from about 10 μm to about 100 μm in diameter. These results are summarized in FIG. 9. The range of surface morphologies seen from the use of different oils is due at least in part to interfacial tensions between the oil and ionic liquid phases, with lower interfacial tensions resulting in more pronounced irregularities on the surface of the bead.

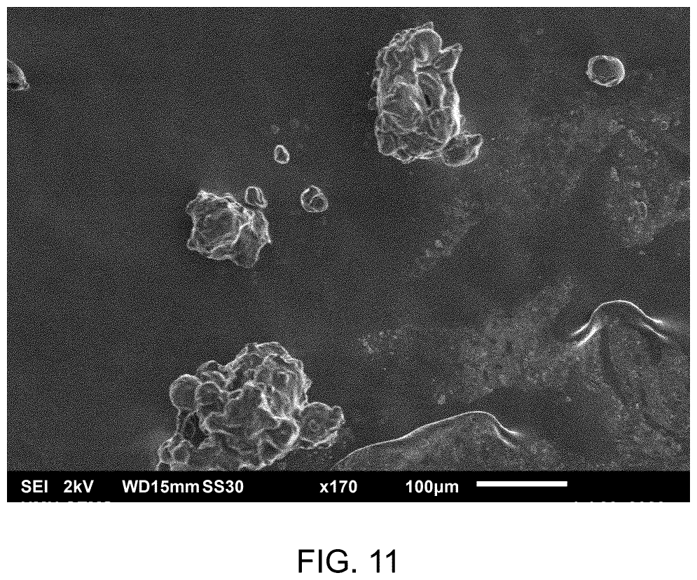

To facilitate the scale-up process and improve the yield of small (e.g., non-aggregated beads), the bead purification process can be modified to include changes to the process such as those depicted in FIG. 10, including vacuum filtering to reduce exposure to atmospheric humidity, draining the oil, replacing ethanol with acetone as a washing solvent, speeding up de-swelling, or any combination thereof. These changes were shown to improve yields (e.g., mass fraction of beads <850 μm in diameter, D) from <30% to >90% in some trials. From top to bottom in FIG. 10, the rows show representative full-sized beads, representative enlarged surfaces of beads, measurements of oil viscosities at room temperature (all oils are Newtonian), measurements of interfacial tension between oil and the ionic liquid/cellulose mixture, and measurements of interfacial tension between oil and ethanol. The mineral oil/S600 column refers to a 75/25 mix by volume of mineral oil/S600 which has similar surface activity to S600 but a lower viscosity. FIG. 11 is an SEM image showing beads taken from a mineral oil/S600 sample with bead sizes as small as 30 μm or 40 μm.

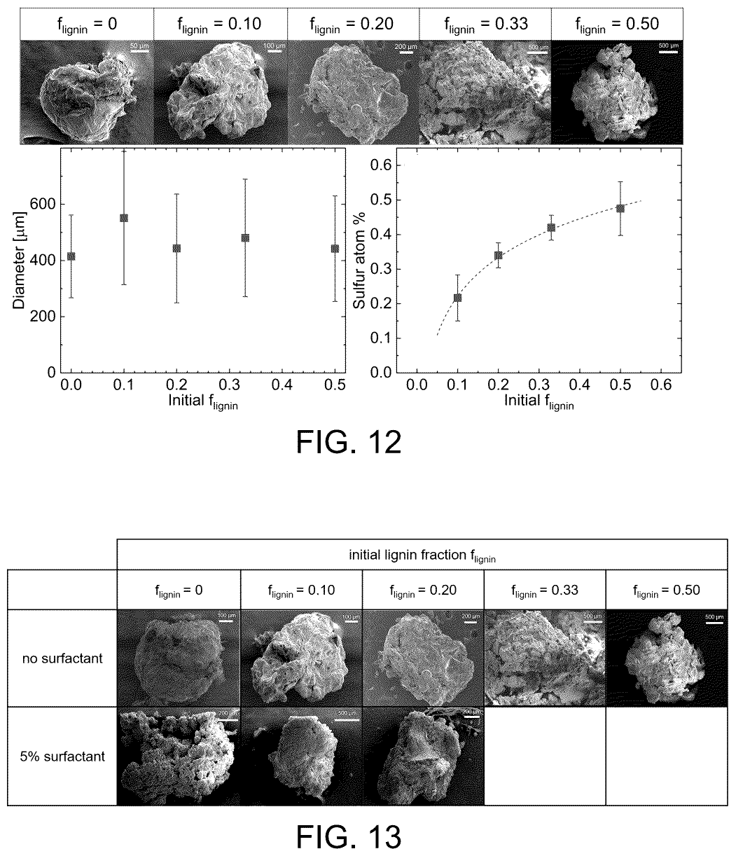

FIG. 12 shows SEM images of microbeads with increasing lignin content. The increasing lignin content shows destabilization of emulsions with increased lignin content, resulting in less regular surface morphology. The lignin containing beads synthesized in the absence of surfactant do not appear to show any correlation between lignin composition and bead size. The sulfur atom % weight in final lignin microbeads, as measured by EDS, is shown to increase with the lignin concentration in the original ionic liquid solution f_{lignin} according to % sulfur=0.16 ln(f_{lignin})-0.15, where f_{lignin} represents the fraction of lignin in the original biomass solution. The sulfur atom incorporation is relevant for lignin incorporation because Kraft lignin contains approximately 2-3% sulfur, suggesting that some lignin is leaching out at initial lignin fractions greater than 10-20%.

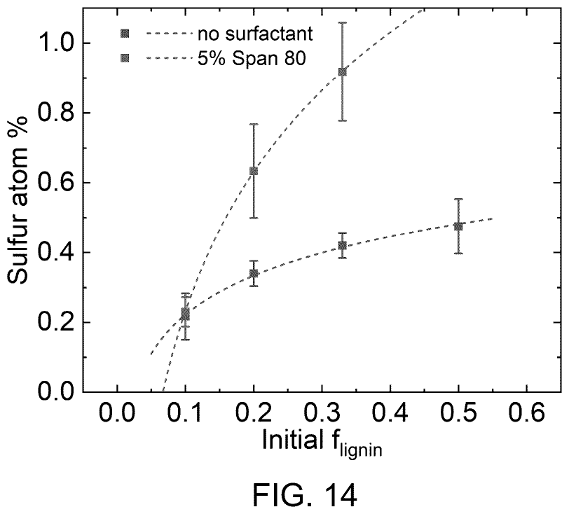

FIG. 13 shows images of microbeads made with and without surfactant (5 wt % Span™ 80). Notably, the microbeads formed with surfactant are similar in appearance to the microbeads formed without surfactant. FIG. 14 shows the effect of Span™ 80 on lignin retention, suggesting that incorporation of Span™ 80 may help prevent lignin leaching at higher initial lignin fractions.

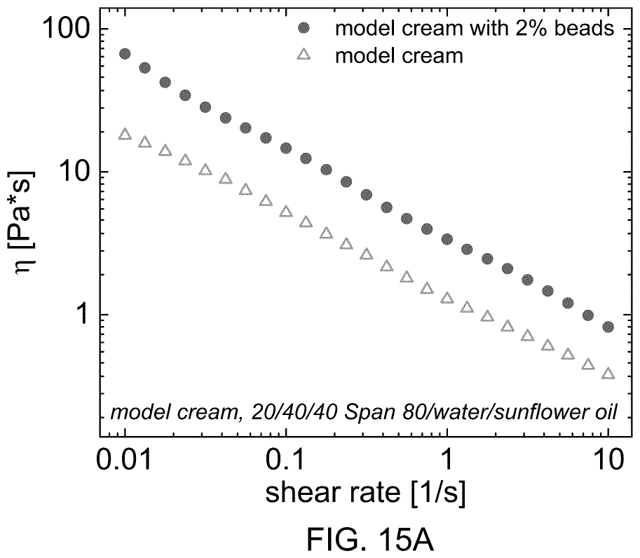

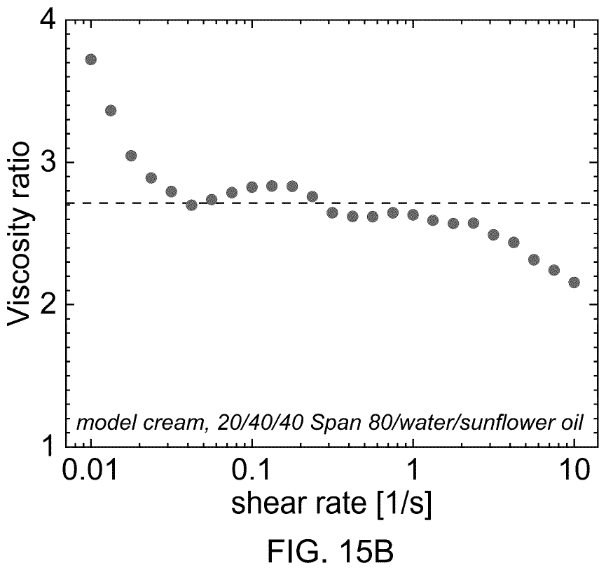

FIGS. 15A and 15B show viscosity and viscosity ratio, respectively, of model cream with 2 wt % and without microbeads made with 20:40:40 Span™ 80, water, and sunflower oil, respectively. The microbeads were from a scale-up fraction having a diameter of at least 850 μm. The viscosity of the model cream is enhanced by approximately a factor of 2.7 for most shear rates.

### OTHER EMBODIMENTS

It is to be understood that while the compounds and methods have been described in conjunction with the detailed description thereof, the foregoing description is intended to illustrate and not limit the scope, which is defined by the scope of the appended claims. Other aspects, advantages, and modifications are within the scope of the following claims.

What is claimed is:

1. Microbeads comprising:
about 50 wt % to about 99 wt % cellulose; and
about 1 wt % to about 50 wt % lignin;
wherein an average diameter of the microbeads is in a range of about 25 microns to about 1500 microns.

2. The microbeads of claim 1, comprising about 1 wt % to about 25 wt % lignin.

3. The microbeads of claim 1, wherein a Young's modulus of the microbeads is in a range of about 0.5 GPa to about 1.5 GPa.

4. The microbeads of claim 1, wherein an average diameter of the microbeads is in a range of about 100 microns to about 800 microns or about 150 microns to about 500 microns.

5. The microbeads of claim 1, wherein the cellulose has a degree of polymerization in a range of about 200 to about 500.

6. The microbeads of claim 1, wherein the microbeads are free of surfactant.

7. The microbeads of claim 1, wherein the microbeads are free of metal oxides.

8. A method of producing microbeads, the method comprising:
dissolving cellulose and lignin in a solvent to yield a biomass solution;
introducing the biomass solution into oil to yield a first mixture;
adding an anti-solvent to the first mixture to yield a second mixture; and
precipitating the microbeads from the second mixture.

9. The method of claim 8, further comprising:
separating the microbeads from the second mixture; and
removing solvent and anti-solvent from the microbeads.

10. The method of claim 8, wherein the solvent comprises an ionic liquid.

11. The method of claim 10, wherein the ionic liquid is 1-ethyl-3-methylimidazolium acetate (EMImAc).

12. The method of claim 8, wherein a concentration of the cellulose in the biomass solution is in a range from about 1 wt % to about 10 wt %.

13. The method of claim 8, wherein a concentration of the lignin in the biomass solution is in a range of about 1 wt % to about 10 wt %.

14. The method of claim 8, wherein the anti-solvent comprises water, ethanol, or a combination thereof.

15. The method of claim 8, wherein the oil comprises mineral oil, vegetable oil, or a combination thereof.

16. The method of claim 8, wherein the introducing comprises dripping.

17. The method of claim 8, wherein the first mixture and the emulsion are free of surfactant.

18. The method of claim 8, wherein the oil is at a temperature in a range of about 30° C. to about 50° C.

19. The method of claim 10, wherein a weight ratio of anti-solvent:oil:ionic liquid in the second mixture is in a range of about 20 to about 25:about 1 to about 5:about 1.

20. The method of claim 9, wherein the removing the solvent and the anti-solvent comprises thermal extraction.
